(19) United States
(12) Patent Application Publication
(10) Pub. No.: US 2005/0203716 A1
(43) Pub. Date: Sep. 15, 2005

(54) Method and system for delay defect location when testing digital semiconductor devices

(75) Inventors: Donald V. Organ, Saratoga, CA (US); Jason Doege, Austin, TX (US)

Correspondence Address: Peter GH Hwanglnovys Corporation;Suite 1, 5870 Stoneridge Drive, Pleasanton, CA, 94588, US

(73) Assignee: Inovys Corporation, Pleasanton, CA (US)

(21) Appl. No.: 10/741,110

(22) Filed: Dec. 19, 2003

(51) Int. Cl. G06F 11/30

(52) U.S. Cl. 702/185

(57) ABSTRACT

An invention is disclosed which automates the discovery in a digital logic semiconductor device of the location of a defect which causes signals to propagate in a manner delayed from the defect free condition. A tester operating system controls application of test patterns designed for delay fault discovery and causes a static timing verifier application to choose additional paths to test which in combination, elucidate the location to one segment of the problematical path.

### BACKGROUND OF INVENTION

Defects, which occur in any semiconductor manufacturing process, have various physical dimensions. Those which were common but insignificant when process geometries were at a certain level of resolution may become troublesome at smaller dimensions. A class of defects, called delay defects, cause the circuit to operate more slowly, but does not affect the logical operation of the circuit. Now it has become economically important to discover delay defects which cause signals to propagate slower than acceptable.

Furthermore, many semiconductor devices are speed graded during test and marked as to their performance capability. Slower chips cost the same to manufacture yet potentially earn their manufacturer less in revenue as devices that pass higher thresholds in speed.

It is considered a “best practice” among designers of digital logic semiconductor devices to utilize a software tool known as a static timing analyzer (STA) to help them understand the timing characteristics of their design. This STA tool works on models of the circuit components and therefore allows the designer to analyze the circuit's timing characteristics before the design has been fabricated. Typically, an STA tool operates by calculating the propagation time of a signal through each circuit element. For timing purposes, each circuit element represents a delay element. By summing those delay elements, the STA calculates an end to end path time. A delay element is any component in the circuit to which signal propagation time can be attributed such as a logic gate or the interconnection between two logic gates.

Once the design has been fabricated, automatic test equipment (ATE) can be used to control and observe a device under test (DUT). For example, the ATE could stimulate the DUT with an input signal, and then time how long it takes for a response to that signal to appear at an output. That time could then be reported as the measured propagation delay time. Unlike the STA, which utilizes software models to analyze all delay elements in a path, the ATE can control and observe only the timing end points and not the individual timing elements.

Software tools known as Automatic Test Pattern Generators (ATPG) can generate “path-delay” test patterns. These test patterns can be executed by ATE to detect delay defects in the manufactured design. However, testing of all paths in a design is prohibitively costly since there are a very large number of paths. Therefore, these patterns are generated for testing only the longest paths in a design i.e. the paths with the greatest risk of violating a setup condition because of a delay fault. And, although the ATE can effectively test and measure these paths, the ATE can only observe the path from end-point to end-point. And so, if defects are identified, the defects can only be associated with the entire path, and cannot be isolated to any particular delay element along the path.

Consider the term “excessive propagation delay” to mean the amount by which actual (measured) propagation delay through a delay element or path exceeds that which was predicted by the STA. This invention provides a means by which the excessive propagation delay of specific delay elements in the path can be inferred. Thus, the designer can gain insight into any faulty models or methodologies utilized by the STA.

While the physical defects themselves may be entirely random, the susceptibility of the design to defects may not be uniform and could be improved with more robust design goals. Thus, identifying the location to a delay element could enable an engineer to make design modifications to improve the manufacturing success rates referred to as yield.

During the process of design and verification of semiconductor devices, various software programs are used which model the behavior of the elements under various electrical conditions. These models are abstractions of the true behavior of the circuit. It may be that there is an error in selecting or using the correct model or it may be that the model is not correctly describing the actual behavior in certain situations. The error may not be in manufacturing at all but in the correctness of the model or an error in using a model of a slightly different design element.

There may be many types of physical defects that can cause a delay element to operate slower than intended. However, it is very rare that a defect would cause a delay element to operate faster than detected. And those defects, such as a “short” would typically be detected by other testing techniques. Thus, for the purposes of this invention, it is assumed that a delay defect will cause the circuit to operate slower, but there is no defect which will cause the circuit to operate faster. In the case of an error in one of the model being used, then this assumption is not valid. However, one with ordinary skill in the area of timing analysis will see how this invention could be trivially modified to detect and identify such modeling errors.

Thus it can be appreciated that a solution to the problem of identifying the location and nature of a defect or design error that causes delay is both novel and valuable.

### SUMMARY OF INVENTION

What has been invented is a method of identifying the location within a semiconductor device of a physical or design error which results in the operation of the device to be slower than it was designed for. The method begins by testing the device with test vectors designed to verify an entire path is free of delay defects; then for those paths that exhibit some unacceptable behavior, the method goes further to generate additional tests which each overlap only a portion of the path that has failed.

The method uses a static timing analysis (STA) tool to produce a set of paths for analysis. For each one of these paths, use an automatic test pattern generation (ATPG) tool to develop a path delay test pattern which will detect a failure at the targeted speed and execute it on a tester to measure the path delay. If the device fails to correlate with the STA prediction for that path, then use static timing analysis to determine a set of paths that each overlap segments of the failing path.

The method consists of collecting information about a subset of the delay elements in the design using three sub-processes:

Measure and update: First, a path is selected. The STA is utilized to predict a propagation time for this path. The ATPG is utilized to generate a path-delay pattern for this path. The ATE is utilized to measure the actual propagation time for this path on the DUT.

If, after performing the above sub-process, measurement of a path matches the STA prediction, then all elements on that path can inferred to be performing correctly.

Apportion: In the event that the measurement of the path exceeds the STA prediction, another path is selected such that it overlaps a portion of the prior path. ATPG and ATE are utilized to measure the actual propagation time for this path for comparison against the optimal.

Confirmation: At the conclusion of the “apportion” sub-process, it may be possible to take further steps to confirm the positive excessive propagation delay on some delay elements.

An heuristic method of controlling the individual parts most efficiently has been described herein. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

### BRIEF DESCRIPTION OF DRAWINGS

FIG. 1 is a flowchart of the Measurement and Update sub-process illustrating the steps for determining if the delay on a timing path is excessive in comparison to the defect free state in accordance with one embodiment of the present invention.

FIG. 2 is a flowchart of the Apportion sub-process illustrating the steps for identifying one or more elements on a timing path that contribute to an excessive delay in comparison to the defect free state in accordance with one embodiment of the present invention

FIG. 3 is a flowchart of the Confirmation sub-process illustrating the steps for verifying that a suspected defect occurs on a specific element on a timing path and itself contributes excessive delay in comparison to the defect free state in accordance with one embodiment of the present invention.

FIG. 4 is a block diagram for the system of delay defect location which incorporates the Measurement and Update sub-process, the Apportion sub-process, and the Confirmation sub-process.

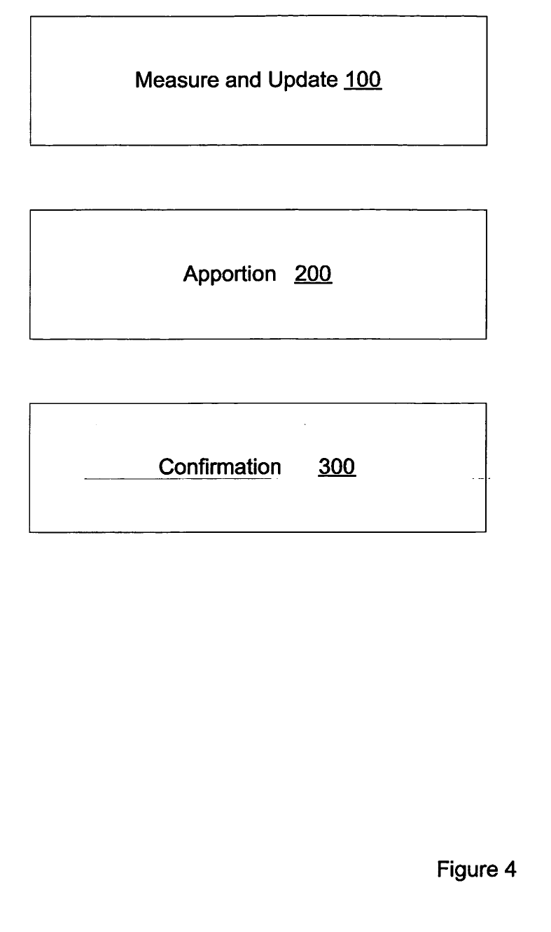

FIG. 5 is a circuit diagram used for illustrative purposes as an example of using the invention to locate a delay defect.

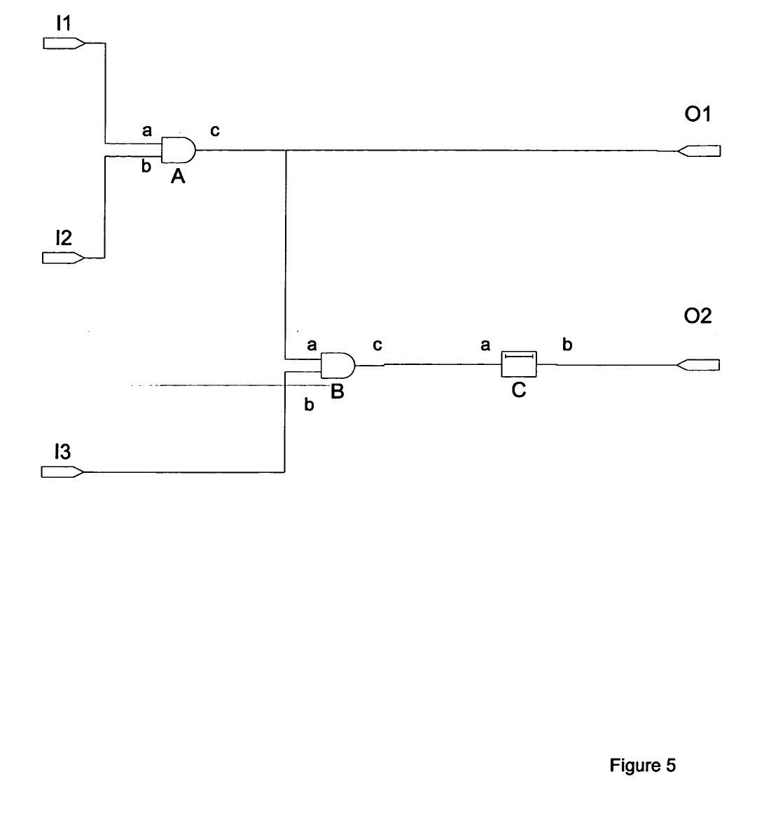

### DETAILED DESCRIPTION

What has been invented is a method of identifying the location within a semiconductor device of a physical or design error which results in the operation of the device to be slower than it was designed for. The method includes testing the device with test vectors designed to verify an entire path is free of delay defects; then for those paths that exhibit some unacceptable behavior, the method goes further to generate additional tests which each overlap only a portion of the path that has failed.

The method provides a way to quickly determine if the failure is localized or systemic. The method provides a process to identify the locality of the failure if it is due to a single segment of the path. The method combines and manages the operation of a semiconductor automated test equipment (ATE), an electronic design automation software tool that synthesizes test patterns (ATPG), and an electronic design automation software tool (STA) which analyzes circuit models for paths which exceed limits of signal propagation.

The method consists of first using a static timing analysis tool to produce a set of paths for analysis. For each one of these paths, use an automatic test pattern generation tool to develop a path delay test pattern which will detect a failure at the targeted speed and execute it on a tester to measure the path delay. If the device fails to correlate with the STA prediction for that path, then use static timing analysis to determine a set of paths that each overlap segments of the failing path. Constructing a database of the delay results, a method of inference will isolate the locus of the defect to a cell or a line segment or a minimal subset of elements of the failing path. The automation of this analysis will allow failing segments to be plotted on a physical display of the layout of the chip for further analysis or correction. As noted earlier the set of all paths in a chip is enormous and even the set of all paths that overlap a given path may be prodigious. Exhaustive methods of generating all possible vectors and storing them economically will not be practical.

The invention is based on the following assumption: The excessive propagation time through a delay element is no greater than the smallest excessive propagation time through any path in which that delay element is in.

Thus, if a given delay element is in multiple paths, and at least one of those paths has zero excessive propagation time, then that delay element can be assumed to have zero excessive propagation time. Thus, when attempting to identify which delay elements contribute to the excessive propagation time of a given path, it may be possible to eliminate from consideration numerous delay elements that are on other paths that have been measured to be without excessive propagation time. If all but one delay element can be eliminated from consideration, then it can be assumed that that delay element contributes the excessive propagation time. And if that delay element is in multiple paths, then that assumption can be reinforced by performing similar analysis on those other paths.

The method consists of collecting information about a subset of the delay elements in the design. This description assumes this information is being kept in a database, but other data management techniques, such as memory resident data structures, could also be used. This database information will include a time value indicating the minimum excessive propagation time through this delay element. The following sub-process will update the database for a particular path:

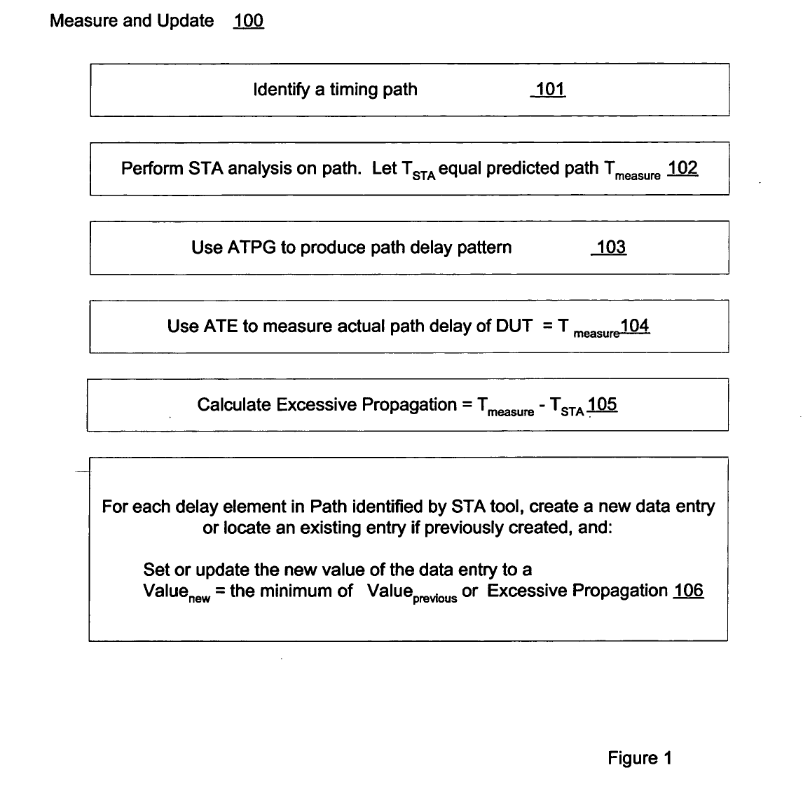

Measure and update: FIG. 1 is a block diagram of the flow of the Measure and update sub-process 100 which creates an initial database of path delays. First, a path is selected using a path identification tool 101. The STA is utilized to predict a propagation time 102 for this path. The ATPG is utilized to generate a path-delay pattern 103 for this path. The ATE is utilized to measure the actual propagation time 104 for this path on the DUT. The difference between the predicted and measured propagation time for the path (i.e. the excessive propagation time) is then used to update the database's minimum excessive propagation time information 106 about each of the delay elements on that path. If this difference is smaller than any previous such difference for a given delay element, then that delay element's value is updated.

If, after performing the above sub-process, a path's measurement matches the STA's prediction, then all elements on that path can inferred to be performing correctly, and the corresponding database entries will be zero. However, if a path's measurement is slower than the STA's prediction, then subsequent analysis is necessary to apportion this excessive propagation time to one or more delay elements. The following sub-process will perform this apportioning:

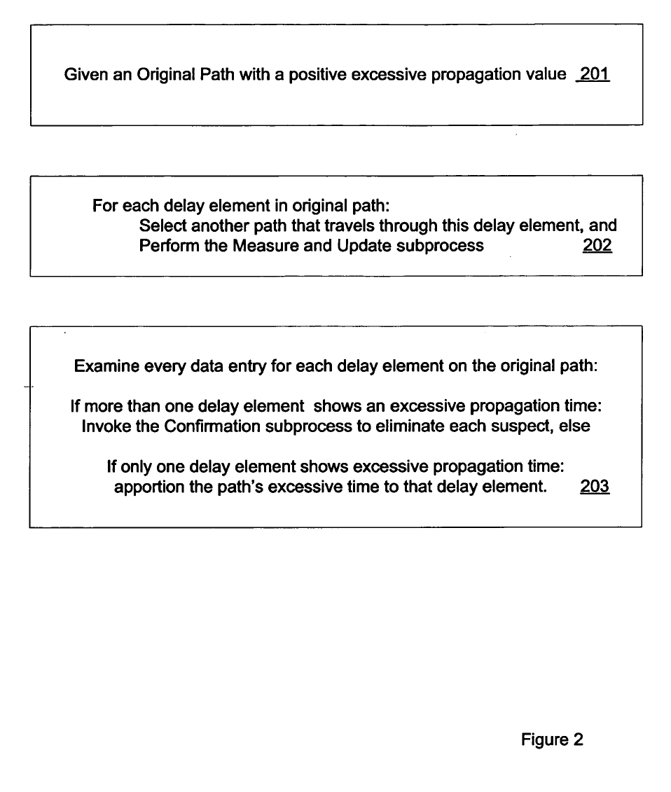

Apportion: FIG. 2 is a block diagram of the flow of the Apportion sub-process 200 which allocates delay to delay elements in a path with excessive propagation delay 201. Another path is selected such that it overlaps a portion of the prior path 202. This overlapped portion should include at least one delay element with a positive excessive propagation time as indicated in the database. The above described “measure and update” sub-process is performed on this path. Then another path is selected that overlaps the original path, again with at least one delay element with a positive excessive propagation time, and the “measure and update” sub-process is performed on that path. This path selection followed by “measure and update” continues until there are no more suitable portions of the prior path to select. At the conclusion of this sub-process, the database can be read to identify delay elements with positive excessive propagation time values 203. It there is more than one such value, then it may be the case that the circuit structure does not present any opportunity to discriminate between those delay elements.

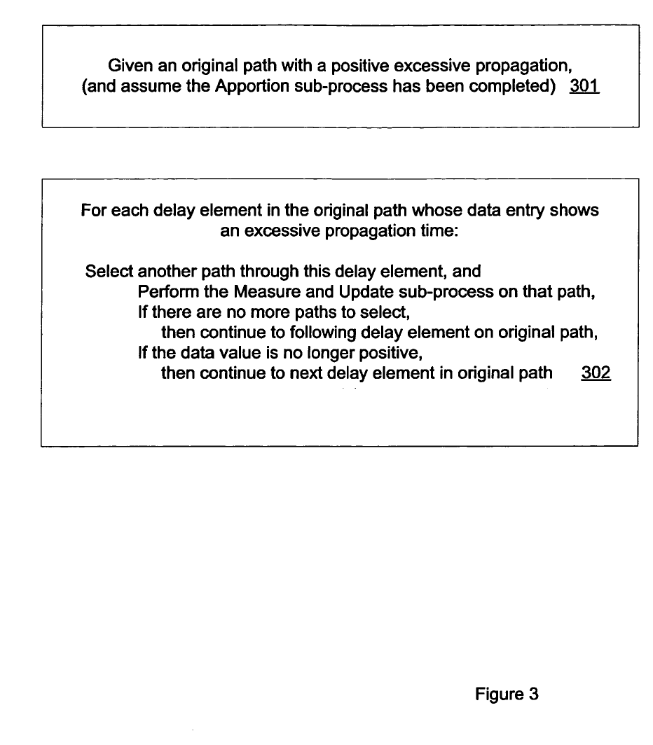

Confirmation: FIG. 3 is a block diagram of the Confirmation sub-process 300 which may be used at the conclusion of the “apportion” sub-process, to take further steps to confirm the positive excessive propagation delay on some delay elements. Other paths can be selected that go through a delay element 302, and the “measure and update” sub-process repeated on those paths. This may reduce the positive excessive propagation delay value in the database for some delay elements. Achieving this will remove the suspicion that a particular delay element has a delay defect. And achieving that will instill more confidence that the excessive propagation delay of a path is attributable to one or more remaining delay elements whose database entries record a positive excessive propagation delay.

An heuristic method 400 of controlling the individual parts most efficiently has been described herein. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Further, although the description has assumed three distinct tools: STA, ATPG, and ATE, it will be appreciated by those of ordinary skill in the art, that the functionalities of these tools could be combined or reorganized without impact to this invention.

By way of illustration but without limiting the description of the invention to the simplified example, the diagram 500 shows a simplified circuit consisting of three input ports (I1, I2, I3), three logic gates (A, B, C) and two output ports (O1, O2). The input ports and output ports represent the timing end-points. So, there are five timing paths (I1->O1, I1->O2, I2->O1, I2->O2, I3->O2). Each of the logic gates have one or two inputs, and one output. Each gate is represented by an upper-case letter (A, B or C). And each input or output on a gate is represented by a lower-case letter (a, b or c). The solid lines between ports and gates represent interconnect. In this simplified example, each interconnect is considered a delay element, and each path through a gate is considered a delay element. For example, the path through Gate A from input (a) to output (c) is a separate delay element then the path through Gate A from input (b) to output (c). Note that this example has other simplifications, such as ignoring signal rise and fall times, and ignoring signal polarity. These simplifications aid in the presentation of this example, but do not represent any limitations of this invention.

Although most STA tools would be more sophisticated, assume for the purposes of this example that the STA first calculates the propagation time through each individual delay element, and then sums the delay elements in a path to yield the path's propagation time.

For the purposes of this example, assume the STA calculates each delay element to have a propagation time of 1 unit of time. There are twelve delay elements in this example, and each is represented in the following table.

TABLE 1
Delay values as determined by an STA

| Delay Element | Delay Time calculated by STA |
|---|---|
| I1 -> Aa | 1 |
| I2 -> Ab | 1 |
| I3 -> Bb | 1 |
| Aa -> Ac | 1 |
| Ab -> Ac | 1 |
| Ac -> O1 | 1 |
| Ac -> Ba | 1 |
| Ba -> Bc | 1 |
| Bb -> Bc | 1 |
| Bc -> Ca | 1 |
| Ca -> Cb | 1 |
| Cb -> O2 | 1 |

There are five paths in this example:

TABLE 2
Paths in this example

| | | Path Delay |
|---|---|---|
| Path Name | Path Description | Calculated By STA |
| I1 -> O1 | I1->Aa, Aa->Ac, Ac->O1 | 3 |
| I1 -> O2 | I1->Aa, Aa->Ac, Ac->Ba, Ba->Bc, | 7 |
| | Bc->Ca, Ca->Cb, Cb->O2 | |
| I2 -> O1 | I2->Ab, Ab->Ac, Ac->O1 | 3 |
| I2 -> O2 | I2->Ab, Ab->Ac, Ac->Ba, Ba->Bc, | 7 |
| | Bc->Ca, Ca->Cb, Cb->O2 | |
| I3 -> O2 | I3->Bb, Bb->Bc, Bc->Ca, Ca->Cb, | 5 |
| | Cb->O2 | |

Now, for purposes of illustration, assume there is a delay defect in the delay element Ca->Cb such that its actual delay was 3 units of time. Also assume that an implementation of this invention has been invoked to analyze the defective circuit.

This implementation might start by initializing a database representing each delay element. At this point, there is no additional information about each delay element.

TABLE 3
Initialize a database

Delay Element
I1 -> Aa
I2 -> Ab
I3 -> Bb
Aa -> Ac
Ab -> Ac
Ac -> O1
Ac -> Ba
Ba -> Bc
Bb -> Bc
Bc -> Ca
Ca -> Cb
Cb -> O2

Next, assume the invention proceeded to measure the first of the five paths using ATE. This is summarized with the additional column in the following table.

TABLE 4
Post Measurement

| Path | Path | STA calculated | Measurement |
|---|---|---|---|
| name | description | path delay | by ATE |
| I1 -> O1 | I1->Aa, Aa-> | 3 | 3 |
| | Ac, Ac-> | | |
| | O1 | | |

Note that this path does not include the defective delay element (Ca->Cb), so its ATE measurement matches the STA calculations.

The database could then be updated:

TABLE 5
Updated Database After One Measurement

| Delay Element | Update from path I1 -> O1 |
|---|---|
| I1 -> Aa | 0 |
| I2 -> Ab | |
| I3 -> Bb | |
| Aa -> Ac | 0 |
| Ab -> Ac | |
| Ac -> O1 | 0 |
| Ac -> Ba | |
| Ba -> Bc | |
| Bb -> Bc | |
| Bc -> Ca | |
| Ca -> Cb | |
| Cb -> O2 | |

Each of the delay elements in the measured path is updated with the difference between the STA calculation and the ATE measurement. Thus, 3−3=0.

Now assume the other four paths are measured, and after each measurement the database is updated accordingly. The following table summarizes the state of the information after the fifth path.

| | | STA | |
|---|---|---|---|
| Path | | calculated | ATE |
| name | Path description | path delay | Measurement |
| I1 -> | I1->Aa, Aa->Ac, Ac->O1 | 3 | 3 |
| O1 | | | |
| I1 -> | I1->Aa, Aa->Ac, Ac->Ba, Ba->Bc, | 7 | 9 |
| O2 | Bc->Ca, Ca->Cb, Cb->O2 | | |
| I2 -> | I2->Ab, Ab->Ac, Ac->O1 | 3 | 3 |
| O1 | | | |
| I2 -> | I2->Ab, Ab->Ac, Ac->Ba, Ba->Bc, | 7 | 9 |
| O2 | Bc->Ca, Ca->Cb, Cb->O2 | 7 | 9 |
| I3 -> | I3->Bb, Bb->Bc, Bc->Ca, Ca->Cb, | 5 | 7 |
| O2 | Cb->O2 | | |

Note that each path containing the defective delay element Ca->Cb is measured at 2 time units greater than the STA calculations, since that delay elements actual delay is 3 units of time, rather than the 1 unit of time predicted by the STA (3−1=2).

| | | Update | Update | Update | Update |
|---|---|---|---|---|---|
| | | from | from | from | from |
| Delay | Update from | path I1 -> | path I2 -> | path I2 -> | path I3 -> |
| Element | path I1->O1 | O2 | O1 | O2 | O2 |
| I1 -> Aa | 0 | +2 | | | |
| I2 -> Ab | | | 0 | +2 | |
| I3 -> Bb | | | | | +2 |
| Aa -> Ac | 0 | +2 | | | |
| Ab -> Ac | | | 0 | +2 | |
| Ac -> O1 | 0 | | 0 | | |
| Ac -> Ba | | +2 | | +2 | |
| Ba -> Bc | | +2 | | +2 | |
| Bb -> Bc | | | | | +2 |
| Bc -> Ca | | +2 | | +2 | +2 |
| Ca -> Cb | | +2 | | +2 | +2 |
| Cb -> O2 | | +2 | | +2 | +2 |

At this point, all the data is collected, so analysis can begin to draw inferences.

Several of the delay elements are associated with at least one path that measured 0 different compared to the STA. Therefore those elements can assumed to be defect free. These delay elements are: I1->Aa, I2->Ab, Aa->Ac, Ab->Ac, Ac->O1.

However, all the remaining seven delay elements are associated only with paths that measured slower than predicted by the STA. Therefore, those delay elements cannot be confidently inferred to be defect free. However, it is possible to identify some of those delay elements as being more likely defective than others. This is done by the next step of analysis, which is to identify those delay elements that are in all paths that measured slower than the STA (and only in those paths that measured slower than the STA). Thus the following three delay elements are identified: Bc->Ca, Ca->Cb, Cb->O2.

The defect can assumed to be in one of those delay elements, or distributed between those elements. The fore-mentioned list of delay elements correctly includes the defective delay element Ca->Cb. However, it also includes two delay elements that are defect-free in this example (Bc->Ca, Cb->O2). And that is to be expected, since, as examination of the original circuit will reveal, there are no paths where those delay elements can be examined separately.

Note, however, that such analysis is not conclusive. Although a single defect in any of the three delay elements identified may be the most likely explanation, it is possible that multiple defects, in different delay elements could also yield the same measurements.

Most real circuits are more complicated than this example; they have more delay elements and many more paths. A circuit with multiple paths through any given delay element can lead to more conclusive analysis, since any ambiguities in the conclusion of the above example, could be further examined by performing additional timing measurements on additional paths that contain the suspected delay elements.

1. A method, for determining the location of defects of the type which lead to slower than desired transitions of signal values in a semiconductor chip, such method comprising
performing analysis of a design using a static timing analyzer to identify a set of paths in a semiconductor device, wherein such paths demonstrate propagation delays in the defect free state which are close to the threshold of a timing violation at the terminus of the path;
further analysis of the said identified set of paths utilizing an automatic test pattern generation tool, said automatic test pattern generating tool defining a path delay test pattern set which will detect a failure at the targeted speed;
executing this pattern set on a tester equipped with at-speed scan capability; and
performing static timing analysis upon the devices which fail the at-speed scan for that path to determine a set of paths which each overlap segments of said failing path.

2. The method of claim 1 further comprising constructing a database of results accumulated over the course of testing a number of similar but distinct semiconductor devices.

3. The method of claim 1 wherein the control program processes predetermined test program patterns until a failure occurs which suspends the execution of predetermined test and initiates dynamic generation of fault isolation tests.

4. A semiconductor test system for identifying semiconductor chip defects, said defects resulting in slower transitions of signal values than desired, comprising:
a static timing analyzer which identifies a set of paths in a semiconductor device, wherein such paths are near the threshold of a timing violation;
an automatic test pattern generator which performs a path delay test pattern calculated to detect a failure at the targeted speed; and.
a tester equipped with at-speed scan capability.

5. The test system of claim 4 further wherein said test system will further perform static timing analysis upon the devices which fail the at-speed scan for that path to determine a set of paths that each overlap segments of said failing path

6. The test system of claim 4 further comprising a database for storing and retrieving the results of multiple tests performed on semiconductor devices.
